(19) United States
(12) Patent Application Publication
(10) Pub. No.: US 2015/0175130 A1
(43) Pub. Date: Jun. 25, 2015

(54) ELECTRICAL CONNECTION DEVICE FOR A WIPER BLADE MEMBER FOR A MOTOR VEHICLE WIPER SYSTEM

(71) Applicant: Valeo Systèmes d'Essuyage, Le Mesnil Saint Denis (FR)

(72) Inventors: Gérald Caillot, Cernay La Ville (FR); Vincent Izabel, Chilly Mazarin (FR); Jean-Michel Jarasson, Le Mesnil Saint Denis (FR); Philippe Carraro, St-Amant-Tallende (FR)

(21) Appl. No.: 14/575,401

(22) Filed: Dec. 18, 2014

(30) Foreign Application Priority Data
Dec. 20, 2013 (FR) 1363274

(51) Int. Cl. B60S 1/38; B23P 19/00; H01R 13/516; B60S 1/40

(52) U.S. Cl. CPC B60S 1/3805; B60S 1/40; B23P 19/00; H01R 13/516; B60S 2001/3898

(57) ABSTRACT

An electrical connection device for a heating device of a wiper blade member of a motor vehicle wiper system is disclosed. The connection device connects, when the blade member is assembled on an arm head of the wiper system, an electrical power source from the arm head of the wiper system to the heating device. The connection device includes a body configured to be fitted to a mechanical connector of the blade member, and an electrical connection element which allows an electrical connection to be established between the connection device and the heating device through the body. The body is capable of being positioned in the mechanical connector in a direction substantially parallel with the blade member, when the electrical connection device is mounted on the blade member.

The present invention relates to an electrical connection device for a heating device of a wiper blade member of a motor vehicle wiper system, the wiper blade member and the wiper system equipped in this manner.

Motor vehicles are commonly equipped with a wiper installation and washing system in order to ensure wiping and cleaning of the windscreen and to prevent the view that the driver has of his environment from being impaired. Wiper installations comprise arms which carry out an angular back and forth movement and at the end of which there are installed elongate blade members which themselves carry wiper blades which are produced from a resilient material. The blades rub against the windscreen and discharge water, removing it from the field of vision of the driver.

Washing systems comprise a device for supplying a screen washing liquid which is conveyed from a tank located on the vehicle and which is projected in the direction of the windscreen by nozzles which are generally located on the bonnet, on the windscreen aperture grille or, in a more recent version, on the wiper blade member of the windscreen wipers, in particular for blade members of the “flat blade” type, that is to say, for blade members which themselves have a curvature which allows them to be mounted on the arms without the use of clips or bars.

In the case of nozzles which are placed on the blade members or which are directly integrated in the structure of the blade member, the screen washing liquid is conveyed via channels which are fixed to the arms of the windscreen wipers and which are connected to a distribution system of the blade member in the region of a connector which enables an articulated connection to be established between the arm and the blade member. The connector thus comprises holes which are capable of receiving, via a sealed connection, an element for connecting channels to the connector.

When the temperature of the screen washing liquid is too low, for example, below 5° C., the screen washing liquid is heated using a heating device which is in particular provided along the blade member.

An electrical connection device for a device for heating the screen washing liquid of the blade member is known, this connection device comprising an electrical connector which is fixed in a mechanical connector of the blade member, the mechanical connector being used to mount the blade member on the drive arm thereof. Such a connection device is intended to be connected to an electrical power supply source from an arm head of the wiper system.

This being the case, the electrical connection to the heating device is established directly on the blade member in a direction perpendicular relative thereto. Such a connection requires precise assembly of the connection contacts on the blade member, which involves precise sizing of the components which cooperate for this assembly. Such a configuration is therefore difficult to control in the case of production at high rates.

The invention is intended to overcome this disadvantage.

To this end, there has been proposed an electrical connection device for a heating device of a wiper blade member of a motor vehicle wiper system, the connection device being intended, when the blade member is assembled on an arm head of the wiper system, to connect an electrical power source from the arm head of the wiper system to the heating device, the connection device comprising a body which is configured to be fitted to a mechanical connector of the blade member and an electrical connection element which allows an electrical connection to be established between the connection device and the heating device through the body, the body being capable of being positioned in the mechanical connector in a direction substantially parallel with the blade member, when the electrical connection device is mounted on the blade member.

In this manner, the mounting of the connection device on the blade member is facilitated, being reduced to simple insertion of the connection device into the mechanical connector of the blade member by means of the action of guiding the body of the connection device on the mechanical connector. Furthermore, the contact is no longer carried out in an assembly direction perpendicular to the blade member, that is to say, in a precise geometric position which involved precision of the contact components and the control of the contact pressure, as in known technology. The configuration according to the invention therefore allows relatively extensive tolerance of the position on the blade member.

It may in particular be a device for heating a screen washing liquid which passes through the blade member.

The positioning direction is preferably substantially longitudinal relative to the longitudinal extent direction of the blade member.

According to other features of the invention which can be taken individually or in combination:
the body is configured to be inserted into the mechanical connector,
the device comprises one or more electrical connection plug(s) which is/are connected to the body and which is/are capable of being pressed into contact with the heating device,
there are two connection plugs,
the connection plugs are capable of being locked, for example, welded or crimped, to the heating device,
the body and the connection plug(s) are positioned relative to each other or the others in order to allow resin to be tapped from the electrical insulation of the plugs via a hole of the body,
the connection plug(s) comprise(s) contact plates which may or may not be flexible,
the contact plate(s) is/are spaced apart from each other,
the contact plate(s) comprise(s) a portion which forms a contact runner with the heating device,
the body is capable of being mounted on the mechanical connector of the wiper blade member at the same time as the electrical connection is established between the connection element and the heating device,
the contact plates are configured to move into contact with the heating device, when the device is mounted,
the body is configured to be positioned in the mechanical connector at the same time as the heating device to which it has previously been connected.

The invention also relates to a wiper blade member of a wiper system which comprises such an electrical connection device.

The blade member comprises a mechanical connector, the mechanical connector being fixedly joined to the blade member and being provided to be articulated to an arm head of the wiper system.

The mechanical connector and the body of the connection device advantageously comprise mutual guiding means for the insertion of the body of the connection device into the mechanical connecter when it is assembled.

The guiding means are preferably of the type having sliding members.

The heating device which is mounted on the blade member advantageously comprises an electrical contact strip which is configured to cooperate with the connection device.

The electrical contact strip advantageously extends inside the mechanical connector in order to establish the electrical connection.

The guiding means are advantageously configured to allow the connection to be locked, preferably by means of clip-fitting or welding of the connection.

The mechanical connector is advantageously configured to receive the connection element, in particular the contact plugs, in a housing which is formed at the interior thereof, in particular facing the heating device.

The housing is capable of being closed and filled with resin in particular via the hole of the body, which allows the contact plugs to be electrically insulated from each other.

The housing is capable of being closed using a stopper in order to close it for the resin tapping operation.

According to a first embodiment of the invention, the guiding means are advantageously configured to allow, during assembly, a translation movement of the contact plates substantially parallel with the electrical contact strip, preferably in an inclined manner relative to the contact strip, through a small inclination angle, for example, of between approximately 3 and 15°, which ensures contact by means of wedging of the connection to the assembly.

The electrical contact strip is fixedly joined to the blade member. It is orientated in particular in accordance with the longitudinal extent thereof.

According to a second embodiment of the invention, the electrical contact strip is configured to be arranged so as to be fixedly joined to the connection device and to press on the blade member, during assembly, in particular in accordance with the longitudinal extent thereof.

The electrical strip and the connection device are capable of being connected to each other prior to their being mounted in the mechanical connector.

The electrical strip and the connection device, which are connected to each other, are capable of being moved in translation on the blade member in the mechanical connector.

The heating device is fixedly joined to a curvature support structure of the blade member.

The invention also relates to a wiper system which comprises such a wiper blade member.

The invention further relates to a method for assembling such a wiper system, comprising the following steps:
guiding the connection device and/or the connection device and the heating device, which have previously been connected, to the mechanical connector, in a direction substantially parallel with the blade member,
locking the connection. Other features and advantages of the invention will be appreciated from a reading of the following description of embodiments given by way of illustration with reference to the appended Figures, in which:

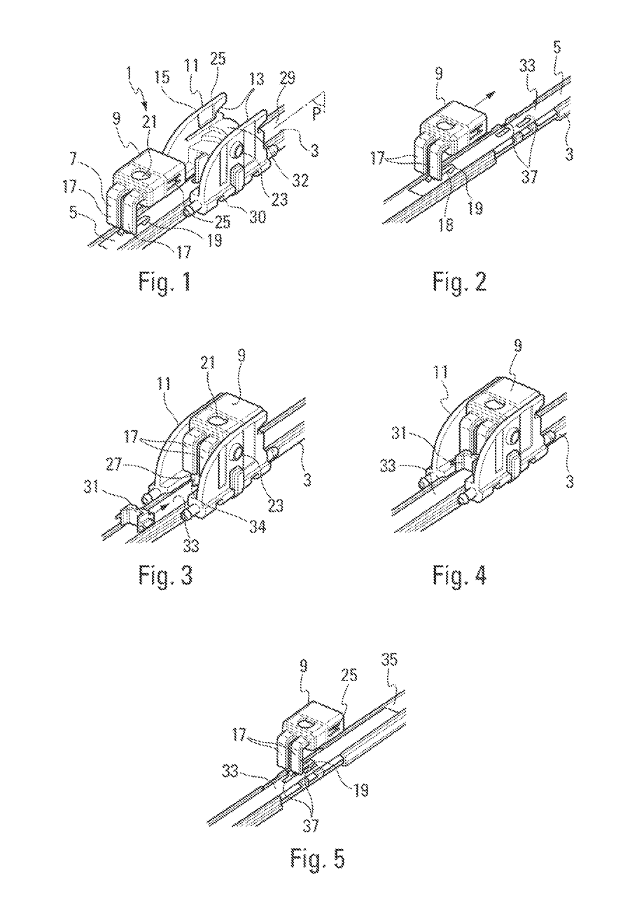

FIG. 1 is a partial perspective view of a wiper system comprising a connection device according to an embodiment of the invention, the connection device being in the process of being assembled,

FIG. 2 is a view similar to FIG. 1 of the wiper system according to FIG. 1, the mechanical connector being omitted for the clarity of the drawing,

FIG. 3 is a view similar to FIG. 1 of the wiper system according to FIG. 1, the connection device being mounted, a resin tapping stopper being in the process of being assembled,

FIG. 4 is a view similar to FIG. 1 of the wiper system according to FIG. 1, the connection device being assembled and the resin tapping stopper also being assembled,

FIG. 5 is a view similar to FIG. 2 of the wiper system according to FIG. 1, the connection device being assembled and the mechanical connector being omitted for the clarity of the drawing, and

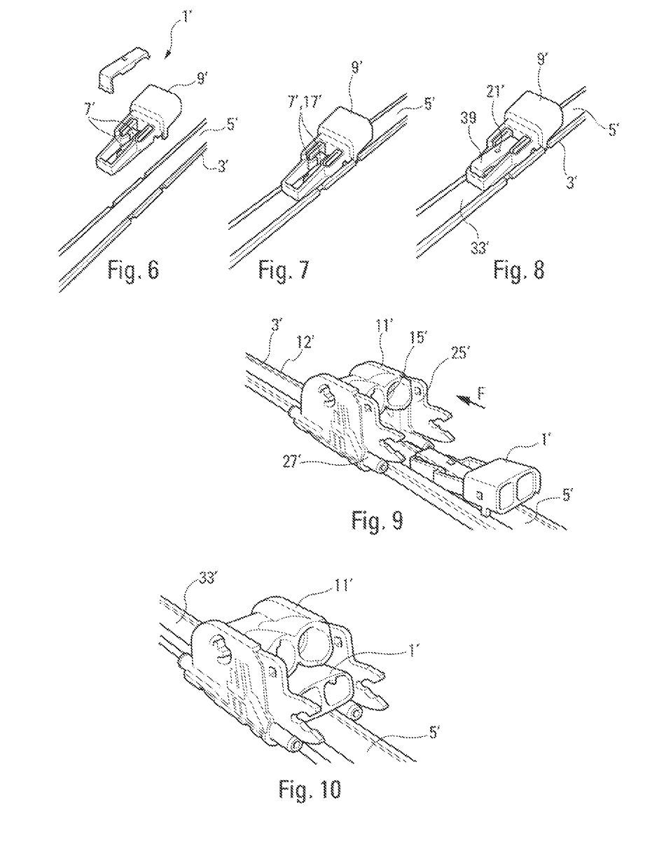

FIGS. 6 to 8 and 9, 10 are perspective views of the connection of the connection device to the heating device and the assembly of the connection device, which has been preassembled on the heating device, on the mechanical connector according to a construction variant of a wiper system according to the invention, respectively.

The same reference numerals have been used to designate elements which are identical or similar.

With reference to the drawings, in particular FIGS. 1 to 5, the invention relates to a connector or electrical connection device 1 for a device 5 for heating screen washing liquid for a wiper blade member 3 of a motor vehicle wiper system.

The connection device 1 is intended, when the blade member 3 is assembled on an arm head of the wiper system, which is not illustrated, to connect an electrical power supply source to the heating device 5.

The connection device 1 is also intended to allow the power supply of the heating device to be disconnected when a wiper blade member is removed, for example, when a worn blade member is removed, for a replacement wiper blade member. The connection device remains fixed to the mechanical connector of the wiper member, an electrical counter-component of this connection device remaining on the arm as described below.

The connection device is intended to be connected, for example, to an electrical interface, which is not illustrated and which may optionally be associated with a hydraulic interface for supplying screen washing liquid. The interfaces are configured to be connected to the arm when a blade member is changed and to leave the blade member free to rotate relative to the arm during use, about an axis orthogonal to the blade member. The electrical interface is in turn connected to an electrical power supply of the vehicle, for example, via an electrical conductor which extends along the arm.

According to the invention, the connection device 1 comprises a body 9 which is configured to be fitted to a mechanical connector 11 of the blade member and an electrical connection element 7 which allows an electrical connection to be established between the connection device 1 and the heating device 5 via the body 9. The body 9 is capable of being positioned in the mechanical connector 11 in a direction substantially parallel with the blade member, when the electrical connection device 1 is mounted on the blade member, see FIGS. 2 and 5 in particular.

In this manner, the mounting of the connection device 1 on the blade member 3 is facilitated since it results from the simple handling of the body. Furthermore, in the embodiment illustrated, the contact is no longer carried out in an assembly direction perpendicular to the blade member 3, that is to say, in accordance with a precise geometric position which involves precision of the contact components and control of the pressure of the contact. It is thus possible to more readily ensure satisfactory contact between the connection device 1 and the heating device 5 of the wiper member, compared with localised positioning on the heating device, in a direction perpendicular to the heating device, as in the prior art mentioned above. Consequently, the device according to the invention will be subjected to greater tolerances of the. assembly components thereof than those of the device of the prior art.

The positioning direction is preferably longitudinal relative to the longitudinal extent direction of the blade member 3.

The body 9 is advantageously capable of being mounted on, in particular inserted into, the mechanical connector 11 of the wiper blade member.

The mechanical connector 11 comprises in this instance, for example, a base 30 which serves, in particular, to fix, in particular to crimp, the connector 11 to the blade member 3 in particular a carrier armature of the blade member. It further comprises lateral flanks 13, for example, extending from the base 30. The mechanical connector 11 may also comprise, in particular between the flanks 13, elements 32 which allow the hydraulic interface mentioned above to be connected to the mechanical connector 5. In this instance, the flanks 13 comprise lateral shaft elements 23 which are used for articulation of the blade member 3 to the arm, in particular via an adapter in the form of a cover which is not illustrated and which covers the connector 11 and is intended to be fixed to the arm head in a removable manner in order to allow the assembly/disassembly of the blade member. The arm head may also be in the form of a cover to internally receive the adapter.

In this instance, the body 9 is received between the flanks 13 of the mechanical connector. It is, for example, inserted at that location via a guiding device 15 during assembly, as will be set out in greater detail below.

The connection device 1 comprises, for example, one or more connection plug(s) 17 which is/are connected to the body 9 and is/are capable of being pressed into contact with the heating device 5, when the body 9 is assembled between the lateral flanks 13. There are two connection plugs 17 which advantageously comprise contact plates 18 which may or may not be flexible.

In this embodiment, the contact plates 18 are configured to move into contact with the heating device 5, when the device is assembled.

They comprise, for example, a portion which forms a contact runner 19 with the heating device 5. These plates 18 are in particular intended to slide via their runner portion 19 on the heating device 5, during assembly.

The contact plugs extend, for example, from the body 9 and are in the form of a hook so as to terminate parallel with the blade member 3 via their contact plate 18.

The contact plate(s) 18 is/are spaced apart from each other and, for example, positioned so as to be longitudinally offset on the heating device 5, as in this instance. The risks of contact between the plates 18 are thus limited.

According to the construction variant illustrated in FIGS. 6 to 10, where similar elements are illustrated with an equivalent reference numeral to which a prime symbol has been added, the connection plugs 17′ are capable of being locked, for example, welded or crimped, to the heating device 5′ and this assembly of the connection device 1′ and the heating device 5′ is what is inserted into the mechanical connector 11′. More specifically in this instance, the heating device 5′ is mounted on a support structure 12″ of the blade member (FIGS. 6 to 8) and the assembly is moved in translation into the carrier armature 3′ of the blade member on which the mechanical connector 11′ has already been assembled (FIGS. 9 and 10).

In these two embodiments, the body 9, 9′ and the connection plug(s) 17, 17′ are positioned one relative to the other or others in order to allow resin tapping of the electrical insulation of the plugs via a hole 21, 21′ of the body. This is because this resin tapping involves an electrically insulating resin which is poured in the liquid or paste-like state via the hole onto the plugs and which solidifies thereon in order to electrically insulate them from the environment, in particular from dust and moisture, and in order to mutually insulate them. This resin remains flexible in order to absorb the micro-movements which are possible between the heating device and the plugs.

The wiper blade member 3, 3′ of the wiper system which comprises the electrical connection device 1, 1′ described above is also the subject-matter of the invention. As mentioned already, it comprises the mechanical connector 11, 11′.

The mechanical connector 11, 11′ and the body 9, 9′ of the connection device advantageously comprise mutual guiding means, such as the above-mentioned guiding means 15 or means 15′ according to the variant, for the insertion of the body of the connection device into the mechanical connector, during assembly. These guiding means 15, 15′ may advantageously be of the type involving sliding members 25, 25′. These sliding members are formed on the mechanical connector, in particular on the flanks thereof, and on the body of the electrical connection device. A means for locking the guiding of the body 9, 9′ in the connector 11, 11′ is provided. The locking is carried out, for example, by means of a plain clip member which cannot be disassembled, of the harpoon type, or ultrasound welding or adhesive bonding.

The mechanical connector 11, 11′ is advantageously configured to receive the contact plugs 17, 17′ in a housing 27, 27′ formed at the interior thereof, opposite the heating device 5, 5′.

According to the first embodiment, the housing 27 is capable of being filled with resin via the hole 21 of the body, which allows the contact plugs 17 to be electrically insulated from each other as mentioned above. This housing 27 is delimited in this instance by the flanks 13 of the mechanical connector, the body 9, the heating device 5 and the upper face 29 of the carrier armature of the blade member. The resin is introduced via the hole 21, which is an upper hole of the body, arranged in alignment with the contact plates 18. Alternatively, there may be no hole for the introduction of the resin.

The housing 27 is capable of being closed longitudinally, at one side, using a stopper 31, in particular a lower stopper, with a view to its closure for the resin tapping operation. This stopper 31 is advantageously provided to be inserted between the wiper member 3, the flanks 13 and the body 9, at the front portion of the housing 27. The housing 27 may be closed longitudinally, at one side, via the element 32 for hydraulic connection. The mechanical connector 11 may also comprise a partition wall 34 for separating the connection plugs 17, the partition wall 34 starting in this instance from the hydraulic connection element 32.

According to the construction variant, the housing 27′ is formed at the lower portion of the connector 11 and receives the body 9′ of the device. The body 9′ is opened via the lower face thereof with respect to the heating device 5′ in order to allow the connection thereof to the electrical connection element. The body is closed by the heating device in the lower region and by an upper cover 39 which covers it. The cover 39 is provided with the hole 21′ for the introduction of the resin for the resin tapping operation. Alternatively, there may be no cover for closing the housing.

In the two methods, the heating device 5, 5′ which is mounted on the blade member advantageously comprises an electrical contact strip 33, 33′ which is configured to cooperate with the connection device 1, 1′.

The electrical contact strip 33 is in the first embodiment arranged so as to be fixedly joined to the blade member 3 and is fixed in particular to the upper face 35 of a support structure of the blade member which has been mounted previously in the carrier armature thereof. This contact strip 33 is configured to receive the contact plates 18 with electrical contact. To this end, it extends at the inner side of the mechanical connector 11. It comprises in particular electrical contact locations 37 which are in the form of a rectangle and which receive the runners 19 of the contact plates at the connection, as illustrated in FIG. 5.

The guiding means 15 are advantageously configured to allow, during assembly, a translation movement of the contact plugs 17 substantially parallel with the electrical contact strip 33. This translation movement is preferably inclined relative to the electrical strip 33 through a small inclination angle which is not illustrated, this angle being, for example, between approximately 3 and 15°. This inclination ensures contact by means of wedging type positioning of the contact plates 18 on the contact strip 33.

According to the variant of the invention, the electrical strip 33′ and the connection device 1′ are capable of being connected to each other prior to being mounted in the mechanical connector 11′.

The electrical contact strip 33′ is in particular provided to be arranged so as to be fixedly joined to the connection device 1′, using the connection of the contact plugs 17′ and the strip 33′, as illustrated in FIGS. 6 to 8. The assembly is pressed onto the blade member 3′, during assembly, in particular in accordance with the longitudinal extent thereof. The device and the strip are in particular moved in translation by the support structure 12 in the mechanical connector 11′ and the carrier armature of the blade member in accordance with the arrow F, during assembly, the device entering the housing 27′ and locking at that location at the end of assembly. In this manner, the electrical connection established between the connection element 7′ and the heating device 5′ may have been produced in any desired assembly direction, for example, parallel or perpendicular, the heating device not yet being mounted on the blade member and the assembly constraints therefore being less significant.

In the two cases, the guiding means 15, 15′ are advantageously configured to allow locking of the connection, at the end of the assembly translation movement, preferably using a stop means of the clip type or a welding of the connection.

The carrier armature of the blade member will be able to act as a support for a wiper blade (not illustrated) which is fitted to one of the faces thereof, and/or to deflection members (not illustrated) which are fitted to the opposing face thereof which is provided in a state supplied with the mechanical connector 11, 11′.

The invention also relates to the method for assembling the wiper system comprising the blade member, as described above.

The method comprises the following steps:
guiding the connection device 1, 1′ which has optionally been pre-assembled with the heating device 5′, on the mechanical connector 11, 11′, in particular using the guiding means 15, 15′, in particular inserting the body 9, 9′ into the mechanical connector 11, 11′ and
locking the connection.

The resin tapping of electrical insulation of the connection plugs 17, 17′ in the housing 27, 27′ formed opposite the heating device 5, 5′ may be carried out, in particular via the hole 21, 21′ for resin injection, prior to the assembly on the blade member or after this assembly.

The invention thus provides a simple and reliable solution for ensuring electrical connection between an electrical power supply circuit and a device for heating screen washing liquid of a wiper blade member of a motor vehicle wiper system.

1. An electrical connection device for a heating device of a wiper blade member, the connection device comprising:
a body which is configured to be fitted to a mechanical connector of the blade member; and
an electrical connection element which allows an electrical connection to be established between the connection device and the heating device through the body,
the body being capable of being positioned in the mechanical connector in a direction substantially parallel with the blade member, when the electrical connection device is mounted on the blade member.

2. The electrical connection device according to claim 1, wherein the body is configured to be inserted into the mechanical connector.

3. The electrical connection device according to claim 1, comprising one or more connection plug(s) which is/are connected to the body and which is/are capable of being pressed into contact with the heating device.

4. The electrical connection device according to claim 3, wherein the body and the connection plug(s) are positioned relative to each other or the others in order to allow resin to be tapped from the electrical insulation of the plugs via a hole of the body.

5. The electrical connection device according to claim 3, wherein the connection plug(s) comprise(s) flexible contact plates which comprise a portion which forms a runner for contact with the heating device.

6. The electrical connection device according to claim 1, wherein the body is capable of being mounted on the mechanical connector at the same time as the electrical connection is established between the electrical connection element and the heating device.

7. The electrical connection device according to claim 1, wherein the body is configured to be positioned in the mechanical connector at the same time as the heating device to which it has previously been connected.

8. A wiper blade member of a wiper system comprising an electrical connection device according to claim 1.

9. A wiper blade member according to claim 8, comprising a mechanical connector, the mechanical connector being fixedly joined to the blade member and being provided to be articulated to an arm head of a wiper system.

10. The wiper blade member according to claim 8, wherein the mechanical connector and the body of the connection device comprise mutual guiding means for the insertion of the body of the connection device into the mechanical connector.

11. The wiper blade member according to claim 8, wherein the mechanical connector is configured to receive the electrical connection element in a housing which is formed at the interior thereof, facing the heating device.

12. The wiper blade member according to claim 11, wherein the housing is capable of being closed and filled with resin.

13. The wiper blade member according to claim 8, wherein the heating device which is mounted on the blade member comprises an electrical contact strip which is configured to cooperate with the connection device.

14. A wiper system comprising a wiper blade member according to claim 8.

15. A method for assembling a wiper blade member according to claim 8, comprising the following steps:
guiding the connection device and/or the connection device and the heating device which have previously been connected, to the mechanical connector, in a direction substantially parallel with the blade member; and
locking the connection.
